(19) United States
(12) Patent Application Publication
(10) Pub. No.: US 2005/0095980 A1
(43) Pub. Date: May 5, 2005

(54) UWB PULSE GENERATOR AND UWB PULSE GENERATION METHOD

(75) Inventor: Heng-Chia Chang, Milpitas, CA (US)

Correspondence Address: SQUIRE, SANDERS & DEMPSEY L.L.P, 600 HANSEN WAY, PALO ALTO, CA, 94304-1043, US

(73) Assignee: BLUE7 COMMUNICATIONS, Milpitas, CA (US)

(21) Appl. No.: 10/709,498

(22) Filed: May 10, 2004

Related U.S. Application Data
(60) Provisional application No. 60/516,046, filed on Oct. 31, 2003.

(51) Int. Cl. H04H 1/00

(52) U.S. Cl. 455/3.02

(57) ABSTRACT

The generator generates UWB pulses by splitting a modulated signal into first and second signals, phase shifting the first signal 180°, and combining the phase shifted signal with the second signal to form a combined signal. The combined signal then can be filtered to remove either positive or negative amplitudes.

### PRIORITY REFERENCE TO PRIOR APPLICATIONS

This application claims benefit of and incorporates by reference U.S. patent application Ser. No. 60/516,046, entitled “Ultra-wideband pulse generator,” filed on Oct. 31, 2003, by inventor Heng-Chia Chang.

### TECHNICAL FIELD

This invention relates generally to ultra-wideband, and more particularly, but not exclusively, provides a system and method for generating ultra-wideband pulses (UWB).

### BACKGROUND

Basic UWB or impulse radio transmitters emit short pulses with tightly controlled average pulse-to-pulse intervals. However, conventional UWB transmitters employ microwave circuits (e.g., high frequency microwave diodes), which can be expensive. Accordingly, a new transmitter and method are needed that do not employ microwave circuitry.

### SUMMARY

Embodiments of the invention enable generation of a UWB pulse train signal CMOS integrated circuitry, thereby lowering cost. In an embodiment of the invention, a generator system comprises an input clock, a grounded line, an output line, and a filter. The input clock generates a modulated pulse train signal. The grounded line, which is communicatively coupled to the input clock, phase shifts the modulated pulse train signal 180°. The output line, which is communicatively coupled to the grounded line and the input clock, combines the modulated pulse train signal and the phase shifted signal. The filter, which is communicatively coupled to the output line, filters out negative or positive amplitudes of the combined signal.

In an embodiment of the invention, the method comprises: modulating a data signal into a pulse train signal; splitting the modulated pulse train signal into a first and a second signal; phase shifting the first signal 180°; combining the phase shifted signal and the second signal; and filtering out negative or positive amplitudes of the combined signal.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network system;

FIG. 2 is a block diagram illustrating a set top box of the network system of FIG. 1;

FIG. 3 is a block diagram illustrating a transmitter section of the set top box of FIG. 2 according to an embodiment of the invention;

FIG. 4 is a timing diagram illustrating signals generated by a transmitter section of the set top box of FIG. 2;

FIG. 5 is a block diagram illustrating a transmitter section of the set top box of FIG. 2 according to an embodiment of the invention;

FIG. 6 is a block diagram illustrating a transmitter section of the set top box of FIG. 2 according to an embodiment of the invention; and

FIG. 7 is a flowchart illustrating a method of generating a UWB pulse.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

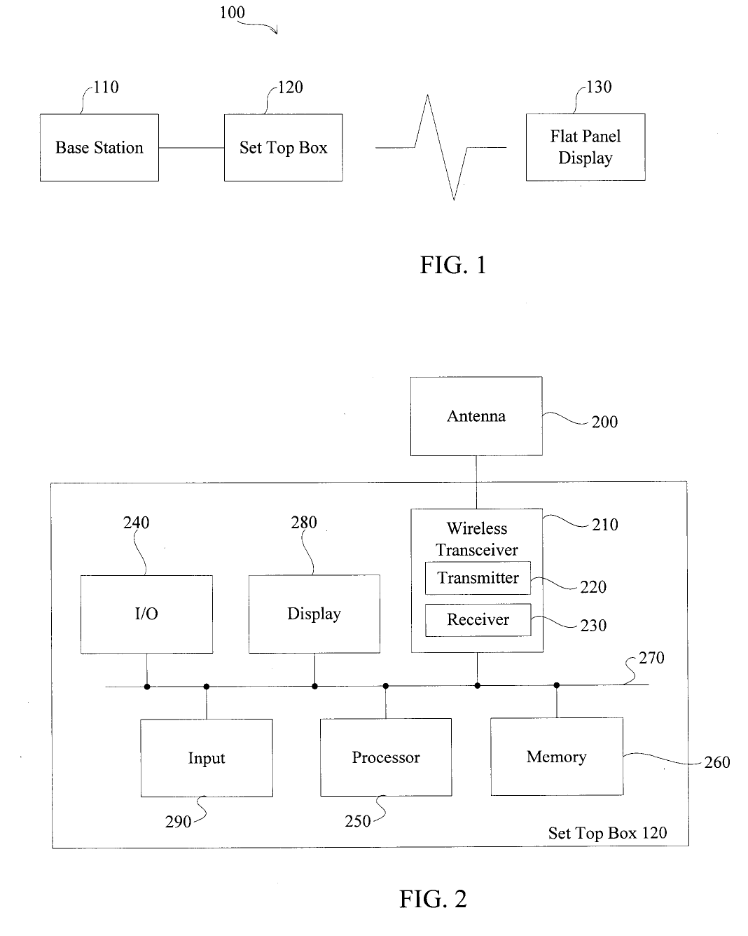

FIG. 1 is a block diagram illustrating a network system 100. A set top box (STB) 120 is communicatively coupled to a flat panel display 130 and a base station 110. In an embodiment of the invention, the STB 120 is wirelessly communicatively coupled to the flat panel display 130 via a UWB link. The connection between the STB 120 and the base station 110 can be wired (e.g., cable) or wireless (e.g., satellite).

During operation of the network system 100, the STB 120 receives television (TV) programming or other data from the base station 110 and transmits it to the flat panel display 130 via UWB. The flat panel display 130 receives the data via UWB, converts the received data to a format capable of being displayed on the display 130 and displays the converted data. Accordingly, by using UWB, the amount of wiring required is reduced.

FIG. 2 is a block diagram illustrating the STB 120 of the network system 100 of FIG. 1. The STB 120 includes a wireless transceiver 210 capable to wirelessly communicate with other wireless devices, such as the flat panel display 130, via UWB; a memory device 260, such as such as a magnetic disk, Random Access Memory (RAM), Flash Memory or other memory device or combination thereof; a processor 250, such as an ARM 7 microprocessor or a Motorola 68000 microprocessor; a display 280; and an input put device 290, all interconnected for communication by a system bus 270. In addition, wireless transceiver 210 is communicatively coupled to an antenna 200. The STB 120 also includes an I/O port 240 for communicatively coupling to the base station 110.

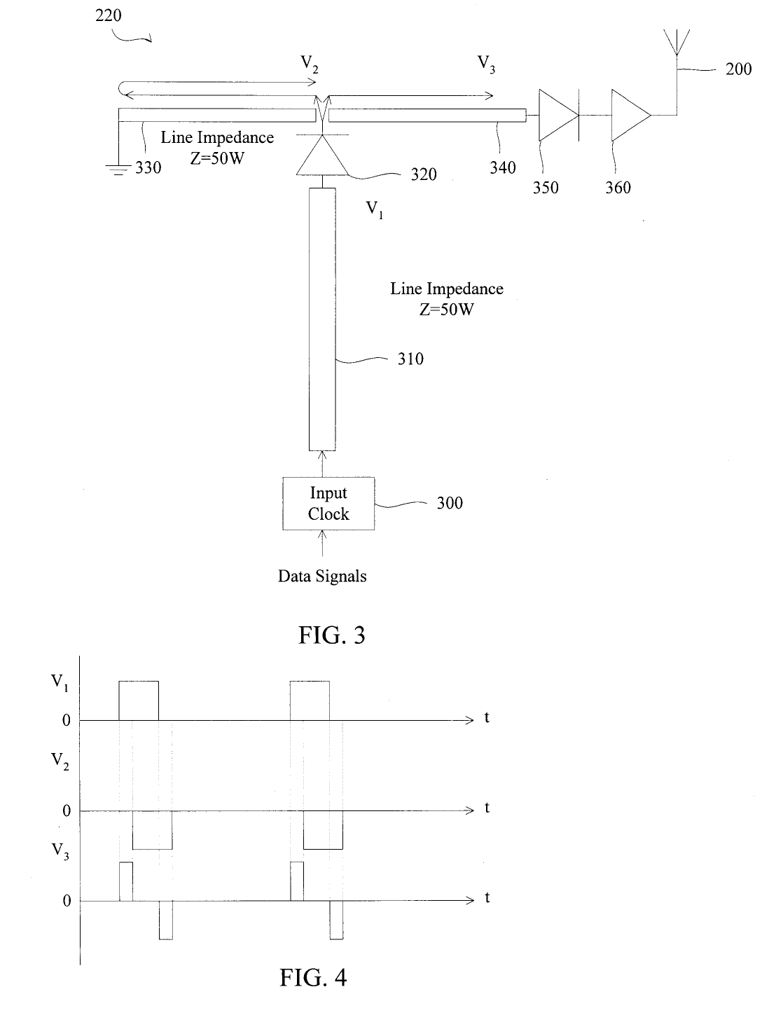

Transceiver 210 can wirelessly transmit and receive data using UWB. The transceiver 210 comprises a transmitter 220 for transmitting data and a receiver 230 for receiving data. The transmitter 220 will be discussed in further detail below in conjunction with FIG. 3.

The processor 250 executes engines stored in the memory 260 to transmit and receive data to other UWB-enabled wireless devices, such as the flat panel display 130. The display 280 comprises a LCD display or other device for displaying data, such as channel selection. Input 290 includes a keyboard and/or other input device and enables a user to change channels.

FIG. 3 is a block diagram illustrating the transmitter section 220 of the STB 120 (FIG. 2) according to an embodiment of the invention. It will be appreciated by one of ordinary skill in the art that the transmitter section 220 (and/or the entire transceiver 210) may be incorporated into any device requiring UWB communication capabilities (e.g., a laptop computer). The transmitter section generates a UWB pulse train with a frequency of 20 megapulses per second (10⁶ pulses per second) with 0.5 ns pulse widths. The transmitter section 220 has very low duty cycles so that the average power time domain is significantly lower than its peak power in the time domain. For example, in an embodiment of the invention, the transmitter section 220 generates signals only 1% of the time (e.g., one 0.5 ns pulse per 50 ns time period).

The transmitter section 220 comprises an input clock 300, a line 310, a step recovery diode 320, a grounded line 330 and an output line 340. The input clock 300 is communicatively coupled to the line 310, which is communicatively coupled to the diode 320. The diode 320 is communicatively coupled to both the grounded line 330 and the output line 340. The output line 340, in an embodiment of the invention, is communicatively coupled to a diode 350 (e.g., a Schottky diode), which is communicatively coupled to an amplifier 360 to the antenna 200.

During operation of the transmitter section 220, data signals from the bus 270 to be transmitted over the antenna 200 are received and input into the line 310 via modulation with clock signals from the input 300 (e.g., each pulse may represent a single bit based on pulse amplitude). The modulated signals have a pulse width greater than the desired pulse width. The modulated signals pass through the diode 320 and are then split between the lines 330 and 340. The signals traveling along the line 330 bounce back and combine with the signals traveling along the line 340. The diode 320 prevents bounce back of the signal to the clock 300.

Since the signals along line 330 are reflected, their phase is shifted 180 degrees. The combined signals have a pulse width of Δt=2L/v wherein L is the length of the line 330 and v is the signal propagation velocity along the line 330. Accordingly, the pulse width can be varied by varying the length of the line 330. The combined signal includes both positive and negative pulses. The signals will be discussed in further detail in conjunction with FIG. 4 below.

After combination of the signals, the combined signal is then filtered by the diode 350 to remove negative or positive pulses. The filtered signal is then amplified by the amplifier 360 and output by the antenna 200.

FIG. 4 is a timing diagram illustrating signals generated by the transmitter section 220. At V₁ (line 310), pulses with time widths larger than the desired time widths are generated by the input clock 300. Some of the signals from V₁ are then split at V₂ (line 330) and reflected with a phase shift of 180 degrees. As the signals at V₂ are offset from the signals of V₁, the combination of the signals from V₁ and V₂ yield the signals of V₃ (line 340) having a pulse width of 0.5 ns with negative and positive amplitudes (one of which can be filtered out by the diode 350). As discussed above, the pulse width can be varied via varying the length of the line 330.

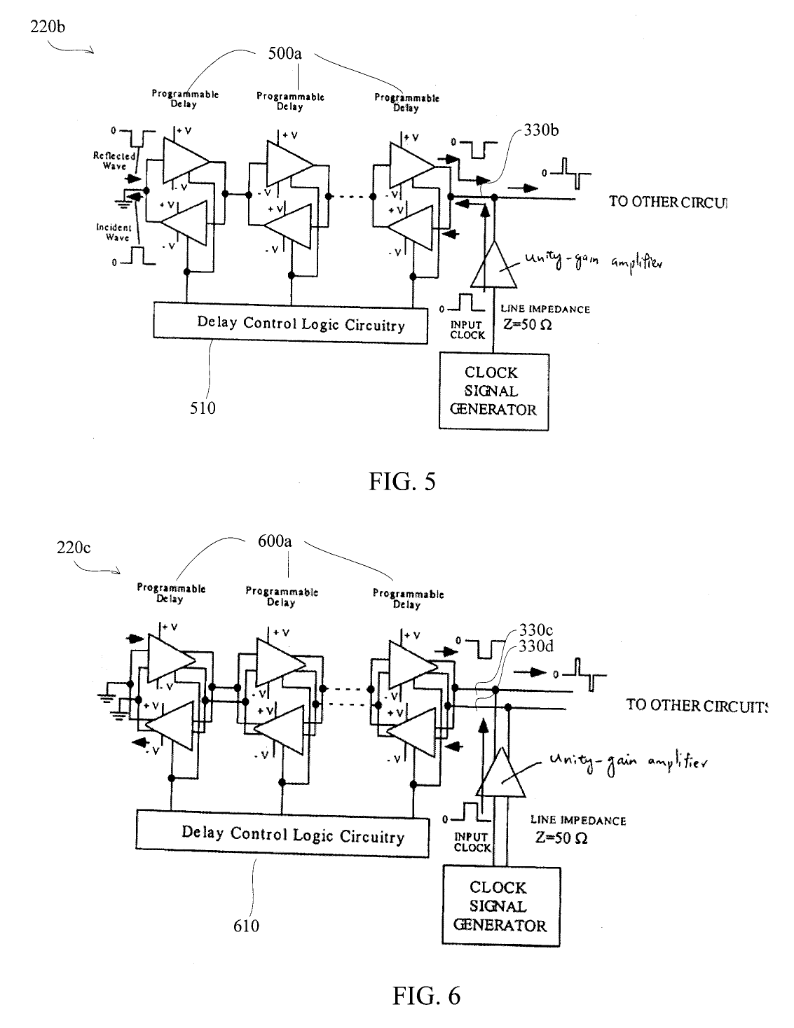

FIG. 5 is a block diagram illustrating a transmitter section 220b according to an embodiment of the invention and FIG. 6 is a block diagram illustrating a transmitter section 220c according to an embodiment of the invention. The transmitter sections 220b and 220c are similar to the transmitter section 220 except that they include programmable delays and related delay control circuitry to manage pulse widths. Specifically, the transmitter section 220b (of FIG. 5) includes a plurality (e.g., 3) of programmable delays 500a along the grounded line 330b. The delays 500a are controlled by delay control logic circuitry 510, which can be implemented as an Application Specific Integrated Circuit (ASIC) or via other technology. Similarly, the transmitter section 220c (of FIG. 6) includes a plurality of programmable delays 600a along the grounded lines 330c and 330d. The delays 600a are controlled by delay control logic circuitry 610.

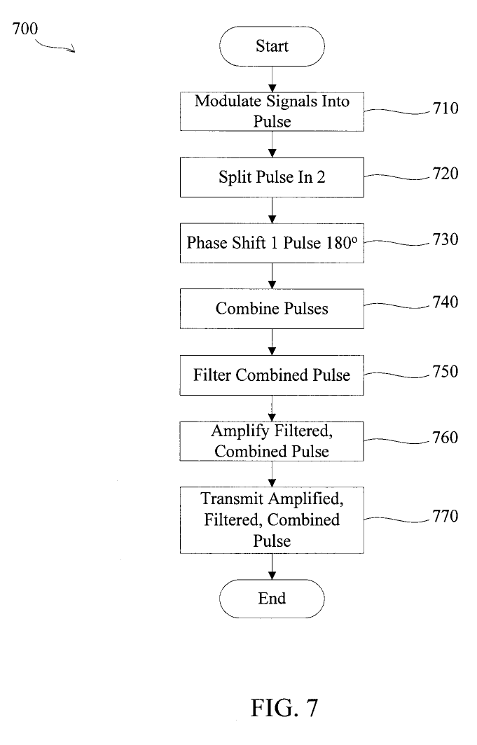

FIG. 7 is a flowchart illustrating a method 700 of generating a UWB pulse. In an embodiment of the invention, the transmitter section 220, 220b or 220c can implement the method 700. First, a data signal is modulated (710) into a pulse signal. The pulse is then split (720) in two with one portion being phase shifted (730) 180°. The phase shifted pulse and the original pulse are then combined (740) to form a pulse with negative and positive amplitudes and having a width of, for example, 0.5 ns. The width can be determined based on the grounded line 330 length and/or on programmable delays incorporated into the grounded line 330. The combined pulse is then filtered (750) to remove either the positive or negative pulses. The filtered pulse is then amplified (760) and transmitted (770). The method 700 then ends.

The foregoing description of the illustrated embodiments of the present invention is by way of example only, and other variations and modifications of the above-described embodiments and methods are possible in light of the foregoing teaching. For example, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method of generating a UWB pulse train signal, comprising:
modulating a data signal into a pulse train signal;
splitting the modulated pulse train signal into a first and a second signal;
phase shifting the first signal 180°;
combining the phase shifted signal and the second signal; and
filtering out negative or positive amplitudes of the combined signal.

2. The method of claim 1, further comprising amplifying the filtered, combined signal and transmitting the amplified, filtered, combined signal.

3. The method of claim 1, wherein the pulse width of the combined signal is proportional to a grounded line length that is used to perform the phase shift.

4. The method of claim 1, wherein the pulse width is variable according to programmable delays incorporated into a grounded line that is used to perform the phase shift.

5. The method of claim 1, wherein the phase shifting is performed by reflecting the first signal in a grounded line.

6. A UWB signal generator system, comprising:
an input clock capable of generating a modulated pulse train signal;
a grounded line, communicatively coupled to the input clock, capable of phase shifting the modulated pulse train signal 180°;
an output line, communicatively coupled to the grounded line and the input clock, capable of combining the modulated pulse train signal and the phase shifted signal; and
a filter, communicatively coupled to the output line, capable of filtering out negative or positive amplitudes of the combined signal.

7. The system of claim 6, further comprising an amplifier communicatively coupled to the filter, capable of amplifying the filtered, combined signal; and a transmitter, communicatively coupled to the amplifier, capable of transmitting the amplified, filtered, combined signal.

8. The system of claim 6, wherein the pulse width of the combined signal is proportional to the grounded line length.

9. The system of claim 6, further comprising a programmable delay incorporated into the ground line and wherein the pulse width is variable according to the programmable delay.

10. The system of claim 6, further comprising a diode interposed between the grounded line and the input clock that prevents bounce back of the phase shifted signal to the input clock.

11. The system of claim 6, wherein the filter includes a Schottky diode.

12. A wireless device incorporating the system of claim 6.

13. A system, comprising:
means for modulating a data signal into a pulse train signal;
means for splitting the modulated pulse train signal into a first and a second signal;
means for phase shifting the first signal 180°;
means for combining the phase shifted signal and the second signal; and
means for filtering out negative or positive amplitudes of the combined signal.
